(19) United States
(12) Patent Application Publication
(10) Pub. No.: US 2004/0049529 A1
(43) Pub. Date: Mar. 11, 2004

(54) Partial product generator and multiplier

(76) Inventors: Kaoru Awaka, Tsukuba (JP); Yutaka Toyonoh, Toride (JP); Hideyuki Fukuhara, Ami Inashiki Gun (JP)

Correspondence Address: TEXAS INSTRUMENTS INCORPORATED, P O BOX 655474, M/S 3999, DALLAS, TX, 75265

(21) Appl. No.: 10/458,338

(22) Filed: Jun. 10, 2003

(30) Foreign Application Priority Data
Jun. 10, 2002 (JP) 2002-168923

(51) Int. Cl. G06F 7/52

(52) U.S. Cl. 708/625

(57) ABSTRACT

A partial product generator and a multiplier are configured to provide increased operation speed. First encoder Eⱼ₁ generates control code A₁ and control code A₂ that determine the fold (1-fold or 2-fold) of the partial product with respect to the multiplicand corresponding to bit Y₂ⱼ and bit Y₂ⱼ₋₁ of the multiplier. Second encoder Eⱼ₂ generates control code/ZDT that determines whether the partial product has value “0” corresponding to bit Y₂ⱼ and Y₂ⱼ₊₁ of the multiplier and second control code A₂. Third encoder Eⱼ₃ generates control code Sgn and control code/Sgn that determine the sign of the partial product corresponding to bit Y₂ⱼ₊₁ of the multiplier and bit inversion signal AsX. Since control code/ZDT with a longer generation time is treated in the latter section circuit of bit circuit Pⱼᵢ, it is possible to realize high speed for the process.

### CROSS REFERENCE TO RELATED APPLICATIONS

This application claims priority under 35 U.S.C. 119 of Japanese Patent Application Number 2002-168923, filed Jun. 10, 2002.

### FIELD OF THE INVENTION

This invention pertains to a type of partial product generator and a type of multiplier. In particular, this invention pertains to a type of partial product generator and a type of multiplier that use a secondary Booth encoding method.

### BACKGROUND OF THE INVENTION

FIG. 9 is a diagram illustrating the process of conventional multiplication. In the example shown in FIG. 9, both the multiplicand and the multiplier have 8 bits, and a sign bit is at the most significant bit.

Just as the case of manual calculation of multiplication shown in FIG. 9, in the multiplier, too, multiplication is carried out by first calculating the products of the various bits of the multiplier and the multiplicand to get partial products, and then adding the partial products to get the multiplication result. In the example shown in FIG. 9, by adding the 8 partial products corresponding to the various bits of the multiplier, a multiplication result of (15 bits+1 sign bit) is obtained.

In the adder of partial products, in order to suppress increase in the delay time in company with increase in the number of sections of the adder, the Wallace tree method for forming the adder is usually adopted. For the adder formed using the Wallace tree method, addition processing is carried out in parallel, so that an increase in delay time can be suppressed.

However, for the multiplication method shown in FIG. 9, M partial products are formed in multiplication of an L-bit multiplicand and an M-bit multiplier (here, L and M are any natural numbers). Consequently, as the bit number of the multiplier is increased, the number of partial products also increases in proportion. As a result, the number of adders for forming the Wallace tree increases. This is undesired.

As a method for reducing the number of partial products formed in the process of multiplication, the so-called Booth encoding method may be adopted. This method is usually adopted in a multi-bit parallel type multiplier, etc.

According to nth-order Booth encoding method, the various bits that form the multiplier are grouped for every (n+1) bits, and partial products are formed by means of a simple operation (shift operation, bit inversion operation, etc.) between the code and the multiplicand. In this case, the number of partial products is reduced to 1/n of that in the conventional case. That is, the number of partial products is reduced to {M/n} with respect to bit number M of the multiplier. In the 3^{rd} or higher order of the Booth encoding method, there are some partial products that cannot be generated using a shift operation or another simple operation. Consequently, the number of effective partial products usually becomes {M(n−1)/n}.

In the following, a brief account will be presented on the 2^{nd}-order Booth encoding method.

In the following explanation, in order to facilitate understanding, a 2's complement representation is adopted as the number representation. In a 2's complement representation, a negative number is represented by setting the weight of the most significant bit at −1 fold.

In the 2's complement representation, when an L-bit multiplicand X is represented using its various bit values (X₀-X_{L-1}), the following equation is obtained. [Mathematical formula 1]

$$X = {\sum }_{i = 0}^{L - 2} {2}^{i} {X}_{i} - {X}_{L - 1} {2}^{L - 1} \qquad ( 1 )$$

Similarly, in the 2's complement representation, when M-bit multiplier Y is represented using its various bit values (Y₀-Y_{M-1}), the following equation is obtained. [Mathematical formula 2]

$$Y = {\sum }_{k = 0}^{M - 2} {2}^{k} {Y}_{k} - {Y}_{M - 1} {2}^{M - 1} \qquad ( 2 )$$

In multiplication of numbers represented in 2's complement representation, as shown in FIG. 9, the code bits of the partial product are extended to the high-order bit side. Also, the partial product of the sign bit with multiplication of the sign bit of the multiplier and the multiplicand is multiplied by −1 and then added to the other partial product.

The secondary Booth code is obtained by performing the following deformation for the multiplier. First of all, as shown in FIG. 10, the multiplier is divided from the most significant bit at 2-bit intervals. Then, the even-numbered bits counted from the most significant bit are added with the same sign to the position I bit on the high-order side, and, at the same time, inverted and added to the same position (that is, multiplied with −1). In the binary method, the position 1 bit on the high-order side has 2-fold weight. Consequently, when the value added to the high-order position and the value obtained by multiplying with −1 are added, said weight becomes 1-fold. That is, in this deformation, there is no change in the value of the multiplier.

When said deformation is performed for Equation 2, the following equation is obtained.

[Mathematical formula 3]

$$Y = {\sum }_{i = 0}^{M / 2 - 1} {2}^{j} ( - 2 {Y}_{2 j + 1} + {Y}_{2 j} + {Y}_{2 j - 1} ) \\ = {\sum }_{j = 0}^{M / 2 - 1} {2}^{j} {Z}_{j} \qquad ( 3 )$$

In Equation 3, code Zⱼ indicates the secondary Booth code corresponding to the jth partial product. In the aforementioned equation, the value “0” is provided to bit (Y₋₁) that is insufficient on the least significant side.

When multiplicand X shown in Equation 1 is multiplied to multiplier Y shown in Equation 3, one gets the following equation.

[Mathematical formula 4]

$$XY = ( {\sum }_{j = 0}^{L - 2} {2}^{i} {X}_{j} - {X}_{L - 1} {2}^{L - 1} ) ( {\sum }_{k = 0}^{M - 2} {2}^{k} {Y}_{k} - {Y}_{M - 1} {2}^{M - 1} ) \\ = {\sum }_{j = 0}^{M / 2 - 1} {2}^{j} ( {\sum }_{i = 0}^{L - 2} {2}^{i} {X}_{i} - {X}_{L - 1} {2}^{L - 1} ) {Z}_{j} \qquad ( 4 )$$

As can be seen from Equation 4, by using secondary Booth code Zⱼ, it is possible to half the number of partial products.

FIG. 11 is a diagram illustrating the corresponding relationship between the secondary Booth code and the bit value of the multiplier.

As shown in FIG. 11, the secondary Booth code can take any of the following values: −2, −1, 0, 1 and 2. As can be seen from these values, operation of the Booth code on the multiplicand performed for generating a partial product becomes a simple operation, such as a shift operation, bit inversion operation, etc.

FIG. 12 is a diagram illustrating the results of operation for the sign bit, intermediate bit, least significant bit, and negative correction bit of a partial product corresponding to various values of the Booth code.

Here, a negative correction bit refers to a bit that indicates the value added to the least significant bit after inversion of each bit having a positive value when a positive value is multiplied with −1 to be converted to a negative value in the 2's complement representation. It has the same weight as that of the feast significant bit.

In order to realize the operation shown in FIG. 12, usually, several control codes are generated corresponding to the Booth codes, and shift operation, bit inversion operation, etc. are carried out corresponding to the control codes.

FIG. 13 is a diagram illustrating a general example of control codes corresponding to secondary Booth codes.

For the four control codes shown in FIG. 13, codes A₁ and A₂ represent control codes pertaining to shift operation of the multiplicand, and codes Sgn and/Sgn (‘/’ indicates inversion) represent control codes pertaining to bit inversion operation.

FIG. 14 is a schematic circuit diagram illustrating an example of a partial product generator using the control codes shown in FIG. 13.

The partial product generator shown in FIG. 14 has Booth encoder BE that outputs four control codes (A₁, A₂, Sgn,/Sgn) corresponding to three multiplier bits (Y₂ⱼ₋₁, Y₂ⱼ, Y₂ⱼ₊₁), and bit circuits BMᵢ (0≦i≦L−1) that perform shift operation and bit inversion operation for the various bits of multiplicands (X₀-X_{L-1}) corresponding to said four control codes and that calculate the various bits of partial products (PP₀-PP_{L-1}). There are {M/2} said partial product generators in the multiplier.

In the example shown in FIG. 14, Booth encoder BE has p-type MOS transistor 10-p-type MOS transistor 13, n-type MOS transistor 20-n-type MOS transistor 23, inverter 30-inverter 37, and transfer gate 50-transfer gate 53.

The circuit composed of p-type MOS transistor 10, p-type MOS transistor 11, n-type MOS transistor 20 and n-type MOS transistor 21 forms a NAND circuit that takes bit Y₂ⱼ and bit Y₂ⱼ₋₁ of the multiplier as input. That is, the source of p-type MOS transistor 10 and the source of p-type MOS transistor 11 are both connected to power source V_{cc}, and the drains are connected through the series circuit of n-type MOS transistor 20 and n-type MOS transistor 21 to reference potential G. Bit Y₂ⱼ of the multiplier is input to the gates of p-type MOS transistor 10 and n-type MOS transistor 20, and bit Y₂ⱼ₋₁ of the multiplier is input to the gates of p-type MOS transistor 11 and n-type MOS transistor 21.

The circuit composed of p-type MOS transistor 12, p-type MOS transistor 13, n-type MOS transistor 22 and n-type MOS transistor 23 forms a NOR circuit that takes bit Y₂ⱼ and bit Y₂ⱼ₋₁ of the multiplier as inputs. That is, the source of n-type MOS transistor 22 and the source of n-type MOS transistor 23 are both connected to reference potential G, and the drains are connected through the series circuit of p-type MOS transistor 12 and p-type MOS transistor 13 to reference power source V_{cc}. Bit Y₂ⱼ of the multiplier is input to the gates of n-type MOS transistor 22 and p-type MOS transistor 12, and bit Y₂ⱼ₋₁ of the multiplier is input to the gates of n-type MOS transistor 23 and p-type MOS transistor 13.

The output of said NAND circuit goes through transfer gate 50 and is input to inverter 33. The output of said NOR circuit is inverted with inverter 34, goes through transfer gate 51 and is input to inverter 33. Control code A₂ is output from said inverter 33. Bit Y₂ⱼ₊₁ of the multiplier is input to the negative input of transfer gate 50 and the positive input of transfer gate 51, and bit Y₂ⱼ₊₁ of the multiplier is inverted with inverter 32 and is input to the positive input of transfer gate 50 and the negative input of transfer gate 51. A transfer gate operates as a switch such that it is ON when a high level signal is input to the positive input and a low level signal is input to the negative input, and it is OFF when signals at inverse levels with respect to the aforementioned signals are respectively input.

The circuit composed of inverter 35-inverter 37, transfer gate 52 and transfer gate 53 forms an exclusive-OR circuit that takes bit Y₂ⱼ of the multiplier and bit Y₂ⱼ₋₁ of the multiplier as input. That is, bit Y₂ⱼ of the multiplier is input through transfer gate 52 to invert 37, and, at the same time, it is inverted with inverter 36 and is then input through transfer gate 53 to inverter 37. Control code A₁ is output from said inverter 37. Bit Y₂ⱼ₋₁ of the multiplier is input to the positive input of transfer gate 52 and the negative input of transfer gate 53, and bit Y₂ⱼ₋₁ of the multiplier is inverted with inverter 35 and is then input to the negative input of transfer gate 52 and the positive input of transfer gate 53.

Bit Y₂ⱼ₊, of the multiplier is inverted with inverter 30 to generate control code/Sgn, and this control code/Sgn is further inverted with inverter 31 to generate control signal Sgn.

In the example shown in FIG. 14, bit circuit BM₁-bit circuit BM_{L-1} corresponding to the various bits (PP₁-PP_{L-1}) of partial product except for the least significant bit have p-type MOS transistors 16-19, n-type MOS transistors 26-29, inverter 40, inverter 41, transfer gate 56 and transfer gate 57.

The parallel circuit of p-type MOS transistor 16 and p-type MOS transistor 18 and the parallel circuit of p-type MOS transistor 17 and p-type MOS transistor 19 are connected in series between power source V_{cc} and node N1. Also, the serial circuit of n-type MOS transistor 26 and n-type MOS transistor 27 and the serial circuit of n-type MOS transistor 28 and n-type MOS transistor 29 are connected in parallel between node N1 and reference potential G. Control code A₁ is input to the gates of p-type MOS transistor 16 and n-type MOS transistor 28, and control code A₂ is input to the gates of p-type MOS transistor 17 and n-type MOS transistor 26. Also, low-order side bit Xᵢ₋₁ of the multiplicand is input to p-type MOS transistor 19 and n-type MOS transistor 27, and high-order side bit Xᵢ of the multiplicand is input to the gates of p-type MOS transistor 18 and n-type MOS transistor 29.

The signal output from node N1 is input through transfer gate 56 to inverter 41, and at the same time, it is inverted with inverter 40, and is then input through transfer gate 57 to inverter 41. Bit signal PPᵢ of the partial product is output from said inverter 41. Control code Sgn is input to the negative input of transfer gate 56 and the positive input of transfer gate 57, and control code/Sgn is input to the positive input of transfer gate 56 and the negative input of transfer gate 57.

In the example shown in FIG. 14, bit circuit BM₀ corresponding to least significant bit PP₀ of the partial product has p-type MOS transistor 14, p-type MOS transistor 15, n-type MOS transistor 24, n-type MOS transistor 25, inverter 38, inverter 39, transfer gate 54 and transfer gate 55.

Among them, the circuit composed of p-type MOS transistor 14, p-type MOS transistor 15, n-type MOS transistor 24 and n-type MOS transistor 25 forms a NAND circuit that has least significant bit X₀ of the multiplicand and control code A₁ as input. That is, the sources of p-type MOS transistor 14 and p-type MOS transistor 15 are connected to power source V_{cc}, and the drains are connected through the serial circuit of n-type MOS transistor 24 and n-type MOS transistor 25 to reference potential G. Control code A₁ is input to the gates of p-type MOS transistor 14 and n-type MOS transistor 24, and least significant bit X₀ of the multiplicand is input to the gates of p-type MOS transistor 15 and n-type MOS transistor 25.

The output of said NAND circuit is input through transfer gate 54 to inverter 39, and, at the same time, it is inverted with inverter 38 and is then input through transfer gate 55 to inverter 39. Least significant bit PP₀ of the partial product is output from said inverter 39. Control code Sgn is input to the negative input of transfer gate 54 and the positive input of transfer gate 55, and control code/Sgn is input to the positive input of transfer gate 54 and the negative input of transfer gate 55.

In the partial product generator with the aforementioned constitution shown in FIG. 14, control code A₁, control code A₂ and control code Sgn are represented by the following logic formulas.

[Mathematical formula 5]

A₁=Y₂ⱼ⊕Y₂ⱼ₋₁ (5)

A₂=Y₂ⱼ₊₁·(\overline{Y₂ⱼ+Y₂ⱼ₋₁})+\overline{Y₂ⱼ₊₁}·Y₂ⱼ·Y₂ⱼ₋₁ (6)

Sgn=Y₂ⱼ₊₁ (7)

When control code A₁ has value “1” and control code A₂ has value “0,” p-type MOS transistor 17 is ON, while n-type MOS transistor 26 is OFF. Consequently, the inverter that takes the low-order side bit Xᵢ₋₁ of the multiplicand as input becomes inactive, and at the same time, p-type MOS transistor 16 is OFF while n-type MOS transistor 28 is ON. Consequently, the inverter that takes high-order side bit Xᵢ of the multiplicand as input becomes active. As a result, the inverted signal of high-order side bit Xᵢ of the multiplicand is output from node N1.

In this case, when control code Sgn has a value of “0” and control code/Sgn has a value of“1”, transfer gate 56 is ON, and bit PPᵢ of the partial product becomes a value equal to the signal obtained by inverting the signal of node N1, that is, high-order side bit Xᵢ of the multiplicand. When control code Sgn has value “1” and control code/Sgn has value “0,” transfer gate 57 is ON, and bit PPᵢ of the partial product has a value equal to the value obtained by inverting high-order side bit Xᵢ of the multiplicand.

When control code A₁ has value “1,” bit Y₂ⱼ of the multiplier and bit Y₂ⱼ₋₁ of the multiplier have signs that are different from each other, and both the first item and second item of Equation 6 become value “0,” so that control code A₂ definitely becomes value “0.”

When control code A₁ has value “0” and control code A₂ has value “1,” the state becomes opposite to the aforementioned state in that the inverter that takes low-order side bit Xᵢ₋₁ of the multiplicand as input becomes active while the inverter that takes high-order side bit Xᵢ of the multiplicand as input becomes inactive. Consequently, the inverted signal of low-order side bit Xᵢ₋₁ of the multiplicand is output from node N1.

In this case, when control code Sgn has value “0” and control code/Sgn has value “1,” transfer gate 56 becomes ON, and bit PPᵢ of the partial product becomes a value equal to that of low-order side bit Xᵢ₋₁ of the multiplicand. When control code Sgn has value “1” and control code/Sgn has value. “0,” bit PPᵢ of the partial product becomes equal to the value obtained by inversion of low-order side bit Xᵢ₋₁ of the multiplicand.

When both control code A₁ and control code A₂ have value “0,” p-type MOS transistor 16 and p-type MOS transistor 17 are ON, and n-type MOS transistor 26 and n-type MOS transistor 28 are OFF. Consequently, node N1 enters the high-level state, that is, it has value “1.”

In this case, when control code Sgn has value “0” and control code/Sgn has value “1,” transfer gate 56 becomes ON, and bit PPᵢ of the partial product has value “0.” When control code Sgn has value “1” and control code/Sgn has value “0,” bit PPᵢ of the partial product always has value “1.”

The operation explained above is for bit circuits BM₁-BM_{L-1}. The same operation takes place when value “0” is input as low-order side bit Xᵢ₋₁ of the multiplicand to said bit circuits BM₁-BM_{L-1} in bit circuit BM₀ of the least significant bit.

Also, as the negative correction bit, control code Sgn is output as it is.

In the partial product generator shown in FIG. 14, control codes Sgn and/Sgn for controlling the sign of the output value of the partial product are used in the last section of the bit circuit, and control codes A₁ and A₂ for controlling the output value of the partial product at 1-fold, 2-fold, or 0-fold of the bit value of the multiplicand are used in the former section of the circuit.

Also, while control codes Sgn and/Sgn are generated at high speed in a simple circuit using inverters alone, control codes A₁ and A₂ are generated using a complicated circuit having more sections of transistors.

Consequently, the control codes for the last section of the circuit (Sgn,/Sgn) are generated at a speed higher than that of the control codes (A₁, A₂ ) for the former section of circuit, and the process of the last section of circuit must wait for the result of treatment of the former section of circuit. Due to such useless standby time in the process, the operation speed of the partial product generator shown in FIG. 14 cannot be increased sufficiently. This is undesirable.

Also, as can be seen from the relationship shown in FIG. 13, in the partial product generator shown in FIG. 14, when the secondary Booth code Zⱼ has value “0,” there are two types of representation for the output value. That is, when all control codes A₁, A₂, and Sgn have value “0,” the output value becomes “0” for all bit values including the sign bit and the negative correction bit. On the other hand, when control codes A₁ and A₂ have value “0,” and control code Sgn has value “1,” the output value becomes “1” for all bit values. Consequently, it is necessary to determine the sign of the partial product in the last section, and it is impossible to change the process order.

In addition, the presence of two types of representations in the equivalent output value means that even although there is no change in the value of the partial product generated, in the partial product generator, there is still a chance of transition for the state of the signal. Usually, power consumption P of a CMOS circuit can be represented as the following function of signal transition rate at, capacitance C, power source voltage V, and operation frequency f:

P=αCV²f

Consequently, when signal transition rate α increases due to transition of the signal state as aforementioned, wasteful power consumption P increases. This is undesirable.

The objective of this invention is to solve the aforementioned problems of conventional methods by providing a type of partial product generator and a type of multiplier characterized by the fact that an even higher operation speed can be realized.

### SUMMARY OF THE INVENTION

In order to realize the aforementioned purpose, pertaining to the first viewpoint of this invention, this invention provides a type of partial product generator characterized by the following facts: in the partial product generator of multiplier, based on one of plural 2-bit data obtained by dividing the supplied multiplier data from the most significant bit at 2-bit intervals, and the 1-bit adjacent data adjacent to the low-order side of said 2-bit data, a prescribed operation is performed for the supplied multiplicand data so as to generate a partial product corresponding to said 2-bit data; in this partial product generator, there are the following parts: a first encoder that performs exclusive-OR for the low-order data of said 2-bit data and said data adjacent to said low-order data to generate a first control code, and performs exclusive-NOR for said low-order data and said adjacent data to generate a second control code; a second encoder that performs exclusive-NOR for the high-order data and the low-order data of said 2-bit data, and performs NAND for said operation result and said second control code, or OR for the NOT result of said operation result and said first control code to generate a third control code; plural selectors that output the high-order data or low-order data among the adjacent 2-bit data of said multiplicand data corresponding to said first control code and said second control code; plural bit inverters that invert the logic values of the bits of the multiplicand data output from said plural selectors corresponding to the high-order data of said 2-bit data; and plural output circuits that perform operation of NAND for each of the bits of the multiplicand data output from said plural bit inverters and said third control code and output the bit data of said partial product.

As a preferable embodiment, said first encoder has the following parts: a first node and a second node, one of which has said low-order data input to it, and the other of which has said adjacent data input to it; a first inverter that inverts the logic value of said first node; a second inverter that inverts the logic value of said second node; a first switch which is turned ON/OFF corresponding to the logic value of the output signals of said first node and said first inverter, and which outputs the input signal of said second node when in the ON state; a second switch which is turned ON/OFF according to the logic value inverted with respect to that of said first switch corresponding to the logic value of the output signals of said first node and said first inverter, and which outputs the output signal of said second inverter when in the ON state; a third switch which is turned ON/OFF according to the logic value inverted with respect to that of said first switch corresponding to the logic value of the output signals of said first node and said first inverter, and which outputs the input signal of said second node when in the ON state; a fourth switch which is turned ON/OFF according to the same logic value as that of said first switch corresponding to the logic value of the output signals of said first node and said first inverter, and which outputs the output signal of said second inverter when in the ON state; a third inverter that receives the output signals of said first switch and said second switch and outputs NOT of the logic value of said output signals as said first control code; and a fourth inverter that receives the output signals of said third switch and said fourth switch and outputs NOT of the logic value of said output signals as said second control code.

Pertaining to the second viewpoint, this invention provides a type of multiplier characterized by the following facts: the multiplier has plural partial product generators which perform prescribed operations for the supplied multiplicand data to generate partial products corresponding to the plural 2-bit data obtained by dividing the supplied multiplier data from the most significant bit at 2-bit intervals based on said 2-bit data and the 1-bit adjacent data adjacent to the low-order side of said plural 2-bit data, respectively, and an adder that adds the partial products generated in said plural partial product generators; each of said partial product generators has the following parts: a first encoder that performs exclusive-OR for the low-order data of said 2-bit data and said adjacent data adjacent to said low-order data to generate a first control code, and performs exclusive-NOR for said low-order data and said adjacent data to generate a second control code; a second encoder that performs exclusive-NOR for the high-order data and the low-order data of said 2-bit data, and performs NAND for said operation result and said second control code, or OR for the NOT result of said operation result and said first control code to generate a third control code; plural selectors that output the high-order data or low-order data among the adjacent 2-bit data of said multiplicand data corresponding to said first control code and said second control code; plural bit inverters that invert the logic values of the bits of the multiplicand data output from said plural selectors corresponding to the high-order data of said 2-bit data; and plural output circuits that perform operation of NAND for each of the bits of the multiplicand data output from said plural bit inverters and said third control code and output the bit data of said partial product.

### BRIEF DESCRIPTION OF THE DRAWINGS

FIG. 1 is a block diagram illustrating schematically an example constitution of a partial product generator in the multiplier of an embodiment of this invention.

FIG. 2 is a schematic circuit diagram illustrating a detailed constitutional example of the partial product generator shown in FIG. 1.

FIG. 3 is a schematic block diagram illustrating an example of the constitution of the adder of partial product in the multiplier pertaining to this embodiment of the invention.

FIG. 4 is a diagram illustrating the relationship between the value of the control code and the output value of the bit circuit in the partial product generator shown in FIG. 2.

FIG. 5 is a diagram illustrating the results of simulation of the delay time from input of encoder to output of bit circuit in the partial product generators shown in FIG. 2 and FIG. 14.

FIG. 6 is a schematic circuit diagram illustrating another example of a constitution of the second encoder.

FIG. 7 is a schematic circuit diagram illustrating another example of a constitution of the bit circuit.

FIG. 8 is a schematic circuit diagram illustrating another example of a constitution of the first encoder.

FIG. 9 is a diagram illustrating a conventional multiplication process.

FIG. 10 is a diagram illustrating the method for forming the secondary Booth code.

FIG. 11 is a diagram illustrating the corresponding relationship between the secondary Booth code and the bit value of the multiplier.

FIG. 12 is a diagram illustrating the results of operation for a partial product corresponding to the various values of the Booth code.

FIG. 13 is a diagram illustrating a general example of control codes corresponding to the secondary Booth code.

FIG. 14 is a schematic circuit diagram illustrating an example of the partial product generator using the control codes shown in FIG. 13.

### REFERENCE NUMERALS AND SYMBOLS AS SHOWN IN THE DRAWINGS

In the FIGS., 10-19, 101-113 represents p-type MOS transistors, 20-29, 201-213 n-type MOS transistors, 30-41, 301-321 inverters, 50-57, 401-420 transfer gates, 500 a NAND circuit, 600 a NOR circuit, Eⱼ (0≦J≦N−1) a Booth encoder, Eⱼ₁ a first encoder, Eⱼ₂ a second encoder, Eⱼ₃ a third encoder, Pⱼᵢ (0≦j≦L−1) a bit circuit, BE a Booth encoder, and BKₖ (0≦k≦M−1) a bit circuit.

### DESCRIPTION OF THE EMBODIMENTS

In the following, embodiments of this invention will be explained with reference to the figures.

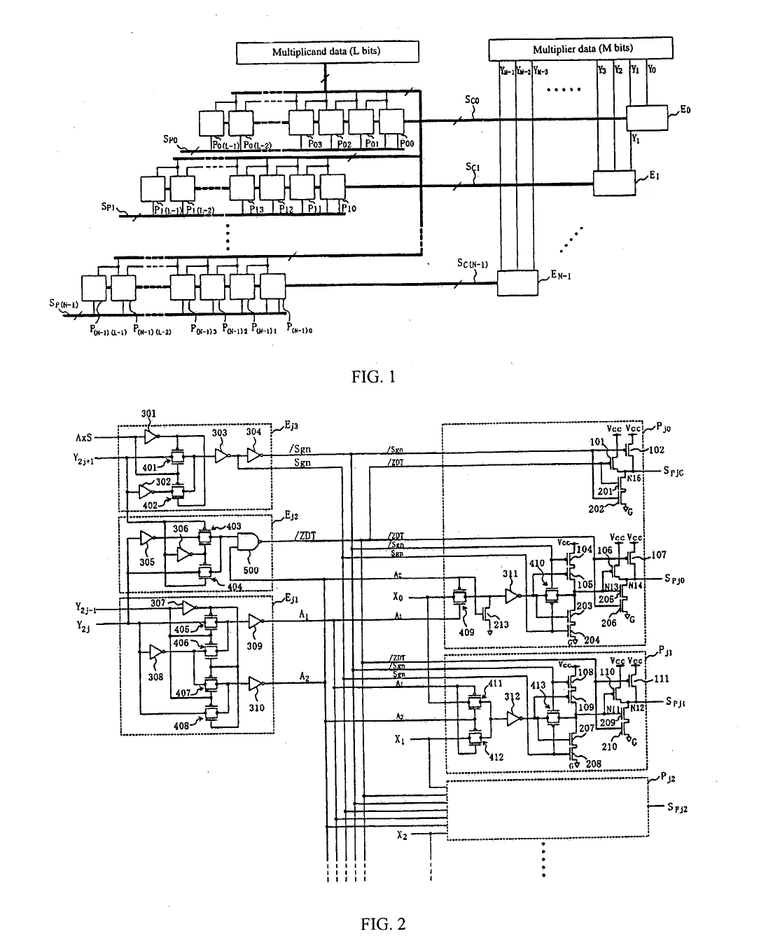

FIG. 1 is a schematic block diagram illustrating an example constitution of the partial product generator in the multiplier as an embodiment of this invention.

In the example shown in FIG. 1, L-bit multiplicand data and M-bit multiplier data are input to the multiplier to generate N (N=M/2) partial products (S_{P0}-S_{P(N-1)}). Partial product generators are set corresponding to said N partial products, respectively.

The partial product generator that generates partial products S_{Pj} (0≦j≦N−1) has Booth encoder Eⱼ and L bit circuits (Pⱼ₀-P_{j(L-1)}).

In Booth encoder Eⱼ, three multiplier bits (Y₂ⱼ₋₁, Y₂ⱼ, Y₂ⱼ₊₁) of the multiplier data are input, and control code S_{Cj} is output corresponding to them. However, Booth encoder E₀ which inputs least significant bit Y₀ of the multiplier inputs value “0” as bit Y₂ⱼ₋₁.

In bit circuit Pⱼᵢ (0≦i≦L−1), bit Xᵢ and bit Xᵢ₋₁ of the multiplicand are input, operation is performed corresponding to control code S_{Cj}, and bit S_{Pji} of the partial product is output. In bit circuit Pⱼₒ corresponding to the least significant bit of the partial product, addition is made to bit S_{Pj0} of the partial product, and bit S_{PjC} corresponding to the negative correction bit is output.

FIG. 2 is a schematic circuit diagram illustrating an example of the detailed constitution of the partial product generator shown in FIG. 1. The same part numbers as those in FIG. 1 are adopted to represent the same structural elements.

In the example shown in FIG. 2, first encoder Eⱼ₁, second encoder Eⱼ₂, and third encoder Eⱼ₃ are contained in said Booth encoder Eⱼ.

First encoder Eⱼ₁ is an embodiment of the first encoder of this invention.

Second encoder Eⱼ₂ is an embodiment of the second encoder of this invention.

Third encoder Eⱼ₃ is an embodiment of the third encoder of this invention.

First encoder Eⱼ₁ has inverters 307-310 and transfer gates 405-408.

Inverter 307 is an embodiment of the first inverter of this invention.

Inverter 308 is an embodiment of the second inverter of this invention.

Transfer gate 405 is an embodiment of the first switch of this invention.

Transfer gate 406 is an embodiment of the second switch of this invention.

Transfer gate 408 is an embodiment of the third switch of this invention.

Transfer gate 407 is an embodiment of the fourth switch of this invention.

Inverter 309 is an embodiment of the third inverter of this invention.

Inverter 310 is an embodiment of the fourth inverter of this invention.

Second encoder Eⱼ₂ has inverter 305, inverter 306, transfer gate 403, transfer gate 404, and NAND circuit 500.

Third encoder Eⱼ₃ has inverters 301-304, transfer gate 401 and transfer gate 402.

Bit circuit Pⱼᵢ (excluding bit circuit Pⱼ₀) has p-type MOS transistors 108-111, n-type MOS transistors 207-210, inverter 312 and transfer gates 411˜413.

The circuit containing transfer gate 411 and transfer gate 412 is an embodiment of the selector of this invention.

The circuit containing inverter 312, transfer gate 403, p-type MOS transistor 108, p-type MOS transistor 109, n-type MOS transistor 207 and n-type MOS transistor 208 is an embodiment of the bit inverter of this invention.

The circuit containing p-type MOS transistor 110, p-type MOS transistor 111, n-type MOS transistor 209 and n-type MOS transistor 210 is an embodiment of the output circuit of this invention.

Bit circuit Pⱼ₀ has p-type MOS transistors 101-102, p-type MOS transistors 104-107, n-type MOS transistors 201-206, n-type MOS transistor 213, inverter 311, transfer gate 409 and transfer gate 410.

The circuit containing transfer gate 409 and n-type MOS transistor 213 is an embodiment of the selector of this invention.

The circuit containing inverter 311, transfer gate 410, p-type MOS transistor 104, p-type MOS transistor 105, n-type MOS transistor 203 and n-type MOS transistor 204 is an embodiment of the bit inverter of this invention.

The circuit containing p-type MOS transistor 106, p-type MOS transistor 107, n-type MOS transistor 205 and n-type MOS transistor. 206 is an embodiment of the output circuit of this invention.

In the following, explanation will be provided for the connection relationship of the partial product generator with the aforementioned constitution shown in FIG. 2.

In first encoder Eⱼ₁, an exclusive-OR circuit that takes bits Y₂ⱼ and Y₂ⱼ₋₁ of the multiplier as input is formed from inverters 307-309, transfer gate 405 and transfer gate 406. That is, bit Y₂ⱼ of the multiplier is input through transfer gate 405 to inverter 309, and at the same time, it is inverted with inverter 308 and is input through transfer gate 406 to inverter 309. First control code A₁ is output from said inverter 309. Bit Y₂ⱼ₋₁ of the multiplier is input to the positive input of transfer gate 405 and the negative input of transfer gate 406, and bit Y₂ⱼ₋₁ of the multiplier is inverted with inverter 307 and is input to the negative input of transfer gate 405 and the positive input of transfer gate 406.

An exclusive-NOR circuit that takes bits Y₂ⱼ and Y₂ⱼ₋₁ of the multiplier as input is formed from inverter 307, inverter 308, inverter 310, transfer gate 407 and transfer gate 408. That is, bit Y₂ⱼ of the multiplier is input through transfer gate 408 to inverter 310, and at the same time, it is inverted with inverter 308 and is input through transfer gate 407 to inverter 310. Second control code A₂ is output from said inverter 310. Bit Y₂ⱼ₋₁ of the multiplier is input to the positive input of transfer gate 407 and the negative input of transfer gate 408, and bit Y₂ⱼ₋₁ of the multiplier is inverted with inverter 307 and is input to the negative input of transfer gate 407 and the positive input of transfer gate 408.

In second encoder Eⱼ₂, an exclusive-NOR circuit that takes bits Y₂ⱼ and Y₂ⱼ₊₁ of the multiplier as input is formed from inverter 305, inverter 306, transfer gate 403 and transfer gate 404. That is, bit Y₂ⱼ of the multiplier is input through transfer gate 404 to NAND circuit 500, and at the same time, it is inverted with inverter 305 and is input through transfer gate 403 to NAND circuit 500. Bit Y₂ⱼ₊₁ of the multiplier is input to the negative input of transfer gate 403 and the positive input of transfer gate 404, and bit Y₂ⱼ₊₁ of the multiplier is inverted with inverter 306 and is input to the positive input of transfer gate 403 and the negative input of transfer gate 404.

The output signal of this exclusive-NOR circuit and the second control code A₂ are input to NAND circuit 500, and third control code/ZDT is output from its output.

In third encoder Eⱼ₃, an exclusive-OR circuit that takes bit inverted signal A×S and bit Y₂ⱼ₊₁ of the multiplier as input is formed from inverters 301-303, transfer gate 401 and transfer gate 402. That is, bit Y₂ⱼ₊₁ of the multiplier is input through transfer gate 401 to inverter 303, and at the same time, it is inverted with inverter 302 and is input through transfer gate 402 to inverter 303. Fourth control code Sgn is output from said inverter 303. Bit inverted signal A×S is input to the positive input of transfer gate 401 and the negative input of transfer gate 402, and bit inverted signal A×S is inverted with inverter 301 and is input to the negative input of transfer gate 401 and the positive input of transfer gate 402.

Fourth control code Sgn is inverted with inverter 304 to generate fifth control code/Sgn.

In bit circuit Pⱼᵢ (excluding i=0), bit Xᵢ₋₁ of the multiplicand is input through transfer gate 411 to inverter 312. Bit Xᵢ of the multiplicand is input through transfer gate 412 to inverter 312. First control code A₁ is input to the negative input of transfer gate 411 and the positive input of transfer gate 412, and second control code A₂ is input to the positive input of transfer gate 411 and the negative input of transfer gate 412.

Transfer gate 413 is connected between the output node of inverter 312 and node N11. Fourth control code Sgn is input to its negative input, and fifth control code/Sgn is input to its positive input. The serial circuit of p-type MOS transistor 108 and p-type MOS transistor 109 is connected between power source V_{cc} and node N11, and the serial circuit of n-type MOS transistor 207 and n-type MOS transistor 208 is connected between node N11 and reference potential G. Fifth control code/Sgn is input to the gate of p-type MOS transistor 108, and fourth control code Sgn is input to the gate of n-type MOS transistor 208. Also, the output signal from inverter 312 is input to the gates of p-type MOS transistor 109 and n-type MOS transistor 207.

A NAND circuit that takes third control code/ZDT and the output signal from node N11 as input is formed from p-type MOS transistor 110, p-type MOS transistor 111, n-type MOS transistor 209 and n-type MOS transistor 210. That is, the parallel circuit of p-type MOS transistor 110 and p-type MOS transistor 111 is connected between power source V_{cc} and node N12, and the serial circuit of n-type MOS transistor 209 and n-type MOS transistor 210 is connected between node N12 and reference potential G. Third control code/ZDT is input to the gates of p-type MOS transistor 111 and n-type MOS transistor 210, and the output signal from node N11 is input to the gates of p-type MOS transistor 110 and n-type MOS transistor 209.

Bit data Sₚⱼᵢ of the partial product are output from said NAND circuit.

In bit circuit Pⱼ₀, bit X₀ of the multiplicand is input through transfer gate 409 to inverter 311. n-type MOS transistor 213 is connected between the input of inverter 311 and reference potential G, and second control code A₂ is input to its gate.

Transfer gate 410 is connected between the output node of inverter 311 and node N13. Fourth control code Sgn is input to its negative input, and fifth control code/Sgn is input to its positive input. The serial circuit of p-type MOS transistor 104 and p-type MOS transistor 105 is connected between power source V_{cc} and node N13, and the serial circuit of n-type MOS transistor 203 and n-type MOS transistor 204 is connected between node N 13 and reference potential G. Fifth control code/Sgn is input to the gate of p-type MOS transistor 104, and fourth control code Sgn is input to the gate of n-type MOS transistor 204. Also, the output signal of inverter 311 is input to the gates of p-type MOS transistor 105 and n-type MOS transistor 203.

A NAND circuit that has the third control code/ZDT and the output signal from node N13 as input is formed from p-type MOS transistor 106, p-type MOS transistor 107, n-type MOS transistor 205, and n-type MOS transistor 206. That is, a parallel circuit of p-type MOS transistor 106 and p-type MOS transistor 107 is connected between power source V_{cc} and node N 14, and a serial circuit of n-type MOS transistor 205 and n-type MOS transistor 206 is connected between node N14 and reference potential G. Third control code/ZDT is input to the gates of p-type MOS transistor 107 and n-type MOS transistor 206, and the output signal from node N13 is input to the gates of p-type MOS transistor 106 and n-type MOS transistor 205.

Bit data Sₚⱼ₀ of the partial product are output from said NAND circuit.

A NAND circuit that has third control code/ZDT and fifth control code/Sgn as input is formed from p-type MOS transistor 101, p-type MOS transistor 102, n-type MOS transistor 201 and n-type MOS transistor 202. That is, a parallel circuit of p-type MOS transistor 101 and p-type MOS transistor 102 is connected between power source V_{cc} and node N15, and a serial circuit of n-type MOS transistor 201 and n-type MOS transistor 202 is connected between node N1 and reference potential G. Third control code/ZDT is input to the gates of p-type MOS transistor 101 and n-type MOS transistor 201, and fifth control code/Sgn is input to the gates of p-type MOS transistor 102 and n-type MOS transistor 202.

Negative correction bit data S_{pjc} that has the same weight as that of bit data Sₚⱼ₀ of the partial product are output from the NAND circuit.

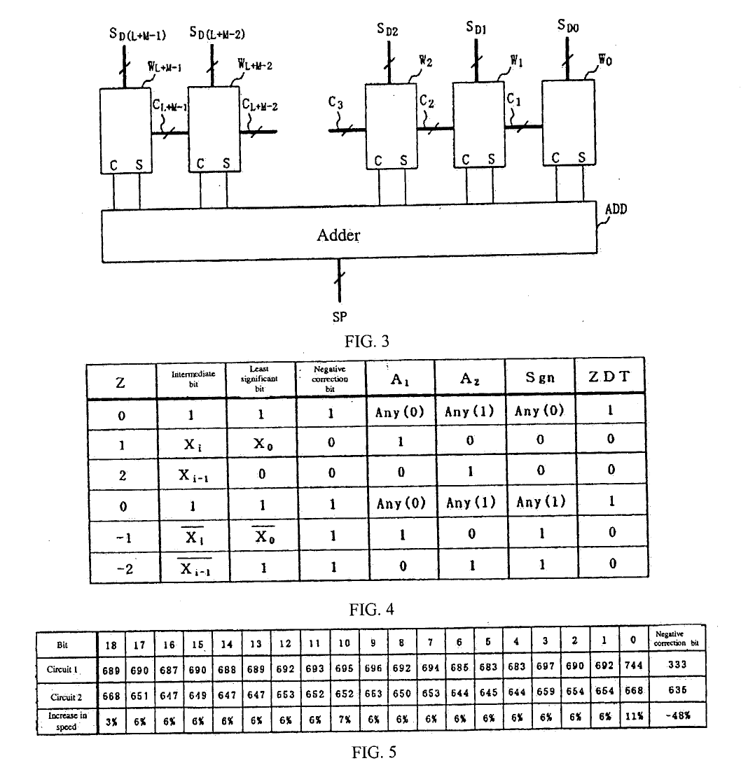

FIG. 3 is a block diagram illustrating schematically an example of the constitution of the adder of the partial product in the multiplier pertaining to an embodiment of this invention.

The adder of the partial product shown in FIG. 3 has Wallace circuit W₀-Wallace circuit W_{L+M-1}, and adder ADD.

For Wallace circuit Wₘ (0≦m≦L+M−1), when the partial product generated in the partial product generator shown in FIG. 2 is added, signal S_{Dm} that collects the bit data added to each other at the same position is input, and addition is carried out using plural internal adders set using the Wallace tree constitution method. In the addition operation, carry signal Cₘ output from Wallace circuit Wₘ₋₁ at the low-order position is used, as, at the same time, carry signal Cₘ₊₁ is output to Wallace circuit Wₘ₊₁ at the high-order position.

Adder ADD adds the addition values and carry values output from Wallace circuits W₀-W_{L+M-1}, respectively.

In the following, an explanation will be provided for the partial product generator with respect to operation of the multiplier having the aforementioned constitution shown in FIGS. 1-3.

The relationship between control codes (A₁, A₂,/ZDT, Sgn) in the partial product generator shown in FIG. 2 and 3-bit multiplier (Y₂ⱼ₋₁, Y₂ⱼ, Y₂ⱼ₊₁) is represented as the following logic formulas.

[Mathematical formula 6]

A₁=Y₂ⱼ⊕Y₂ⱼ₋₁ (8)

A₂=\overline{Y₂ⱼ⊕Y₂ⱼ₋₁} (9)

\overline{ZDT}=({double overscore (Y₂ⱼ₊₁⊕Y₂ⱼ)}{overscore ()·()}{double overscore (Y₂ⱼ₋₁⊕Y₂ⱼ)}) (10)

Sgn=A×S⊕Y₂ⱼ₊₁ (11)

First control code Al and second control code A₂ are control codes for selecting bit Xᵢ or bit Xᵢ₋₁ in the initial-section circuit (selector) of bit circuit Pⱼᵢ and sending it to the intermediate-section circuit (bit inverter).

Third control code/ZDT is a control code for determining whether the output value is value “0” in the last-section circuit (output circuit) of bit circuit Pⱼᵢ.

Fourth control code Sgn and fifth control code/Sgn are control codes for determining the sign of the output value in the intermediate-section circuit of bit circuit Pⱼᵢ. As can be seen from Equation 11, bit inversion signal A×S input to third encoder Eⱼ₃ is a signal for inverting fourth control code Sgn and fifth control code/Sgn. By controlling this signal, it is possible to multiply the output result of the multiplier with 1 or −1.

When third control signal/ZDT has value “0,” p-type MOS transistor 101, p-type MOS transistor 107 and p-type MOS transistor 111 are ON, and n-type MOS transistor 201, n-type MOS transistor 206 and n-type MOS transistor 210 are OFF. Consequently, the output values of bit circuits Pⱼᵢ, including negative correction bit S_{pjc}, all have value “1.”

When third control code/ZDT has value “1,” p-type MOS transistor 101, p-type MOS transistor 107 and p-type MOS transistor 111 are OFF, while n-type MOS transistor 201, n-type MOS transistor 206 and n-type MOS transistor 210 are ON. Consequently, as negative correction bit S_{pjc}, the inverted signal of fifth control code/Sgn is output; as bit Sⱼ₀ of the partial product, the inverted signal of node N13 is output; and, as bit Sⱼᵢ of the partial product (excluding bit Sⱼ₀), the inverted signal of node N11 is output.

When first control code A₁ has value “1” and second control code A₂ has value “0,” transfer gate 411 of bit circuit Pⱼᵢ (excluding bit circuit Pⱼ₀) is OFF, and transfer gate 412 is ON. Consequently, bit Xᵢ of the multiplicand is input to inverter 312.

In this case, when fourth control code Sgn has value “0” and fifth control code/Sgn has value “1,” transfer gate 413 is ON, and at the same time, p-type MOS transistor 108 and n-type MOS transistor 208 become OFF, and the CMOS inverter of p-type MOS transistor 109 and n-type MOS transistor 207 enters the inactive state. Consequently, the inverted signal of bit Xᵢ of the multiplicand that has passed inverter 312 is output to node N11, and its inverted signal, that is, the signal having the same value as that of bit Xᵢ of the multiplicand, is output at the output of bit circuit Pⱼᵢ.

Also, when fourth control code Sgn has value “1” and fifth control code/Sgn has value “0,” transfer gate 413 is OFF, and at the same time, p-type MOS transistor 108 and n-type MOS transistor 208 are ON, and the COMS inverter of p-type MOS transistor 109 and n-type MOS transistor 207 enters the active state. Consequently, a signal having the same value as that of bit Xᵢ of the multiplicand that has passed through two sections of inverters is output to Node N₁₁, and its inverted signal, that is, the inverted signal of bit Xᵢ of the multiplicand, is output at the output of bit circuit Pⱼᵢ.

When first control code A₁ has value “0” and second control code A₂ has value “1, ” transfer gate 411 is ON, and transfer gate 412 is OFF. Consequently, bit Xᵢ₋₁ of the multiplicand is input to inverter 312.

In this case, when fourth control code Sgn has value “0” and fifth control code/Sgn has value “1,” the inverted signal of bit Xᵢ₋₁ of the multiplicand that has passed one inverter section is output to node N11, and its inverted signal, that is, the signal having the same value as that of bit Xᵢ₋₁ of the multiplicand is output at the output of bit circuit Pⱼᵢ.

Also, when fourth control code Sgn has value “1” and fifth control code/Sgn has value “0,” a signal having the same value as that of bit Xᵢ₋₁ of the multiplicand that has passed through two sections of inverters is output to node N11, and its inverted signal, that is, the inverted signal of bit Xᵢ₋₁ of the multiplicand, is output at the output of bit circuit Pⱼᵢ.

In bit circuit Pⱼₒ corresponding to the least significant bit of the multiplier, the operation is performed in the same way as when value “0” is input as low-order side bit Xᵢ₋₁ of the multiplicand to said bit circuit Pⱼᵢ.

That is, when first control code A₁ has value “1” and second control code A₂ has value “0,” bit X₀ of the multiplicand is input to inverter 311. Consequently, when fourth control code Sgn has value “0,” a signal having the same value as that of bit X₀ of the multiplicand is output at the output of bit circuit Pⱼ₀. When fourth control code Sgn has value “1,” the inverted signal of bit X₀ of the multiplicand is output at its output.

Also, when first control code A₁ has value “0” and second control code A₂ has value “1,” value “0” is input to inverter 311. Consequently, when fourth control code Sgn has value “0,” value “0” is output at the output of bit circuit Pⱼ₀. When fourth control code Sgn has value “1,” value “1” is output at its output.

FIG. 4 is a diagram that summarizes the aforementioned relationships between the values of the control codes and the output value of bit circuit Pⱼᵢ.

In FIG. 4, “Any 0” and “Any 1” indicate that any value may be taken as the value of the control code, and the value in the parentheses refers to the actual value adopted in the example shown in FIG. 2.

As can be seen from FIG. 4, when third control code/ZDT has value “1,” all bits of the partial product including the negative correction bit become value “1,” independent of the values of the other control codes. Consequently, when the Booth code has value “0,” the value of the partial product is determined in a single round of operation. Consequently, no transition from the signal state as in the partial product generator shown in FIG. 14 takes place, and power consumption due to said signal transition can be reduced.

In the partial product generator shown in FIG. 2, third control code/ZDT with complicated logic and a large delay time as shown in Equation 10 is used in the last section of bit circuit Pⱼᵢ, and the other control codes with a shorter delay time are used in the former section of circuit. Consequently, the wasteful standby time in the process as in the partial product generator shown in FIG. 14 can be reduced, and the operation speed can be increased.

This feature can be seen by comparing the transistor section number of the longest signal path. For the partial product generator shown in FIG. 14, for the longest signal path from input of Booth encoder BE to output of bit circuit BMᵢ, with bit Y₂ⱼ of the multiplier taken as an input, the signal path goes through p-type MOS transistor 12, n-type MOS transistor 13, inverter 34, transfer gate 51, inverter 33, n-type MOS transistor 26, inverter 40, transfer gate 57 and inverter 41, so there are 9 sections of transistors. On the other hand, for the partial product generator shown in FIG. 2, for the longest signal path from input of Booth encoder Eⱼ to output of bit circuit Pⱼᵢ, with bit Y₂ⱼ₋₁ of the multiplier taken as an input, the signal path goes through inverter 307, transfer gate 405, inverter 309, transfer gate 411, inverter 312, p-type MOS transistor 109 and n-type MOS transistor 209, so there are 7 sections of transistors. That is, the partial product generator shown in FIG. 2 has 2 less transistor sections for the longest signal path than that of the partial product generator shown in FIG. 14.

FIG. 5 is a diagram which compares the results of simulation of the delay time from input of encoder to output of bit circuit in the partial product generators shown in FIGS. 2 and 14.

As can be seen from the results of simulation shown in FIG. 5, compared with the partial product generator shown in FIG. 14, the partial product generator shown in FIG. 2 can increase the operation speed by about 6-7% for each bit. Also, the operation speed decreases by 48% for the negative correction bit, because in the partial product generator shown in FIG. 2, the negative correction bit is generated from AND of fifth control code/Sgn and third control code/ZDT, while in the partial product generator shown in FIG. 14, control code Sgn is directly used as the negative correction bit. However, in the partial product generator shown in FIG. 2, this negative correction bit is the only low-speed bit. Consequently, in the Wallace circuit Wₘ shown in FIG. 3, by adjusting the circuit constitution so that the signal path of the negative correction bit is shorter than the other bits, it is possible to shorten this delay time sufficiently.

In the following, an explanation will be provided for other constitutional examples of the aforementioned multiplier.

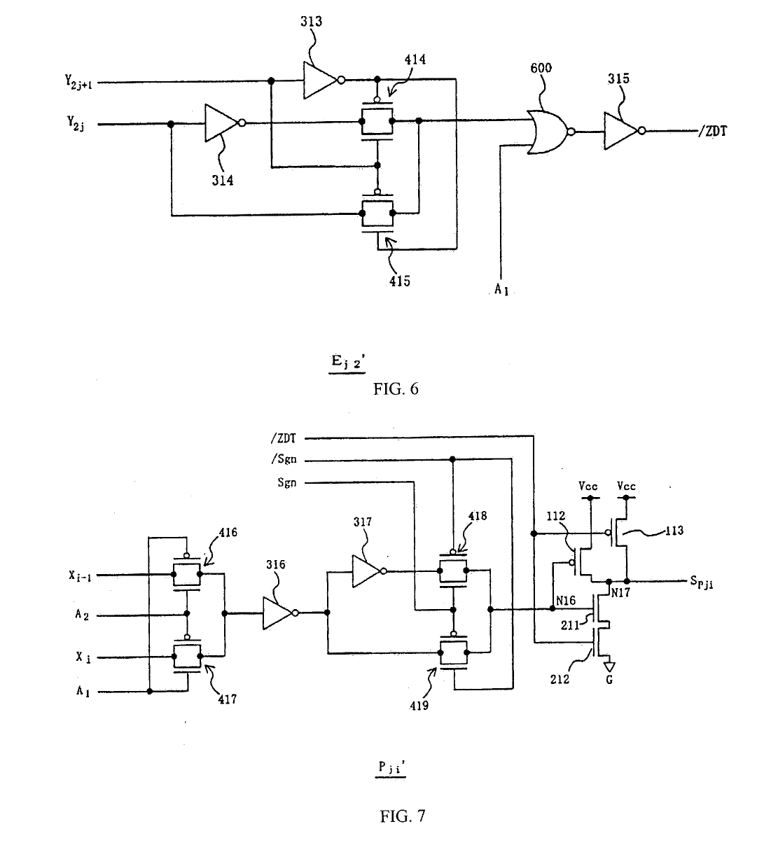

FIG. 6 is a schematic circuit diagram illustrating another example of the constitution of the second encoder.

Second encoder Eⱼ₂′ shown in FIG. 6 has inverters 313-315, transfer gate 414, transfer gate 415 and NOR circuit 600.

In this second encoder Eⱼ₂′, while bit Y₂ⱼ of the multiplier is input through transfer gate 415 to NOR circuit 600, it is inverted with inverter 314 and is then input through transfer gate 414 to NOR circuit 600. Bit Y₂ⱼ₊₁ of the multiplier is input to the positive input of transfer gate 414 and the negative input of transfer gate 415, and bit Y₂ⱼ₊₁ of the multiplier is inverted with inverter 313 and is input to the negative input of transfer gate 414 and the positive input of transfer gate 415. First control code A₁ is input to the other input of NOR circuit 600, and its output is inverted with inverter 315 to generate third control code/ZDT.

In the constitution shown in FIG. 6, too, third control code/ZDT having the same logic value as that of Equation 10 is obtained.

FIG. 7 is a schematic circuit diagram illustrating another constitutional example of the bit circuit.

Bit circuit Pⱼᵢ′ shown in FIG. 7 has p-type MOS transistor 112, p-type MOS transistor 113, n-type MOS transistor 211, n-type MOS transistor 212, inverter 316, inverter 317, and transfer gates 416-419.

In bit circuit Pⱼᵢ′ (excluding i=0), bit Xᵢ₋₁ of the multiplicand is input through transfer gate 416 to inverter 316. Bit Xᵢ of the multiplicand is input through transfer gate 417 to inverter 316. First control code A₁ is input to the negative input of transfer gate 416 and the positive input of transfer gate 417, and second control code A₂ is input to the positive input of transfer gate 416 and the negative input of transfer gate 417.

While the output signal of inverter 316 is input through transfer gate 419 to node N16, it is inverted with inverter 317 and is then input through transfer gate 418 to node N16. Fourth control code Sgn is input to the positive input of transfer gate 418 and the negative input of transfer gate 419, and fifth control code/Sgn is input to the negative input of transfer gate 418 and the positive input of transfer gate 419.

A NAND circuit that takes third control code/ZDT and the output signal from node N16 as input is formed from p-type MOS transistor 112, p-type MOS transistor 113, n-type MOS transistor 211, and n-type MOS transistor 212. That is, a parallel circuit of p-type MOS transistor 112 and p-type MOS transistor 113 is connected between power source V_{cc} and node N17, and a serial circuit of n-type MOS transistor 211 and n-type MOS transistor 212 is connected between node N17 and reference potential G. Third control code/ZDT is input to the gates of p-type MOS transistor 113 and n-type MOS transistor 212, and the output signal from node N16 is input to the gates of p-type MOS transistor 112 and n-type MOS transistor 211.

Bit circuit Pⱼᵢ′ shown in FIG. 7 differs from bit circuit Pⱼᵢ shown in FIG. 2 with respect to the feature that the sign of the output value is controlled by turning ON transfer gate 418 or transfer gate 419 corresponding to fourth control code Sgn and fifth control code/Sgn. Due to this difference, the number of the transistor sections of bit circuit Pⱼᵢ′ is 1 larger than that of bit circuit Pⱼᵢ. When this is adopted in the partial product generator, the transistor sections for the longest path in the partial product generator is only 1 less than for the partial product generator shown in FIG. 14. Also, it is possible to reduce the number of transistors used in the circuit compared to that in bit circuit Pⱼᵢ of FIG. 2.

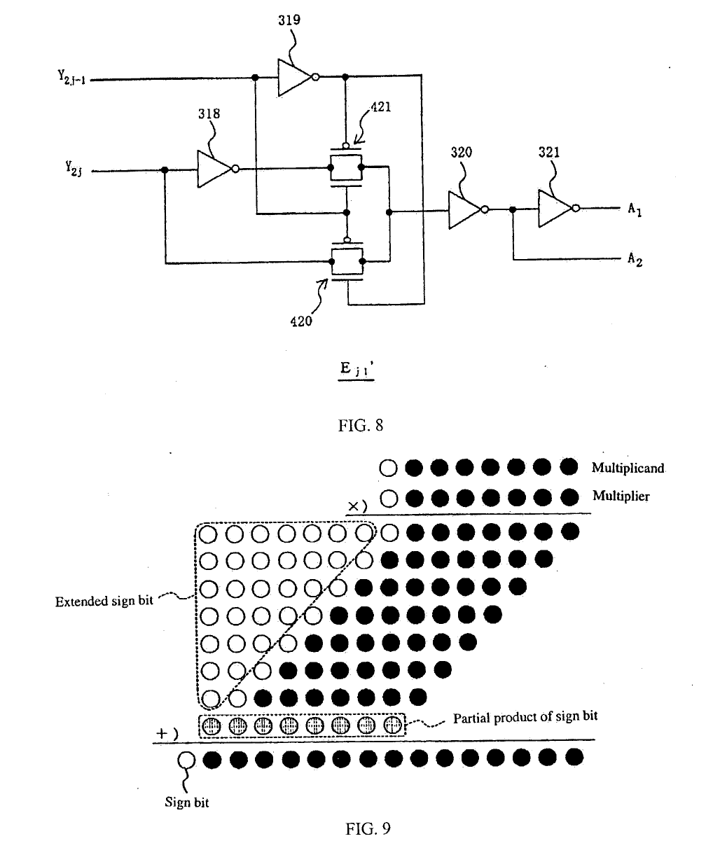

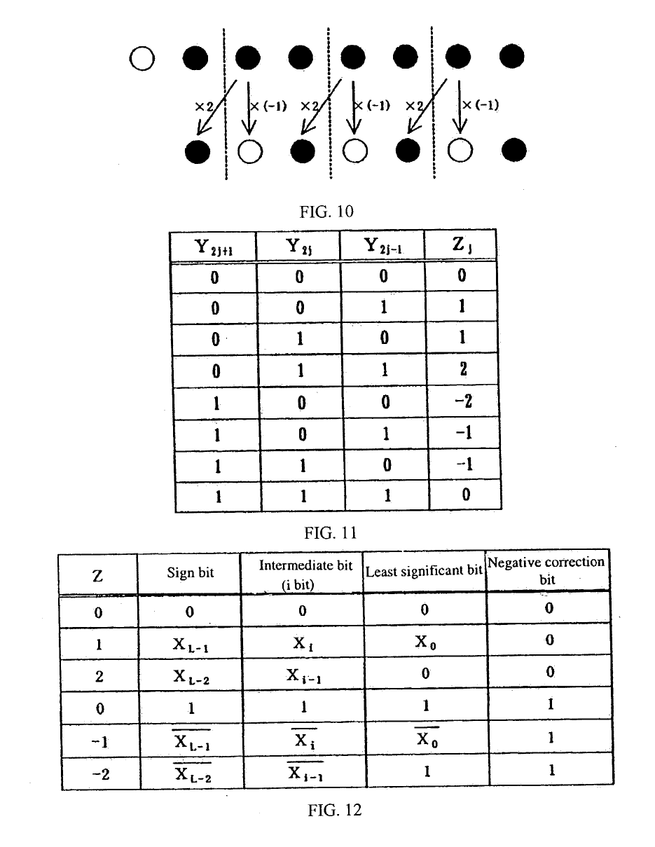

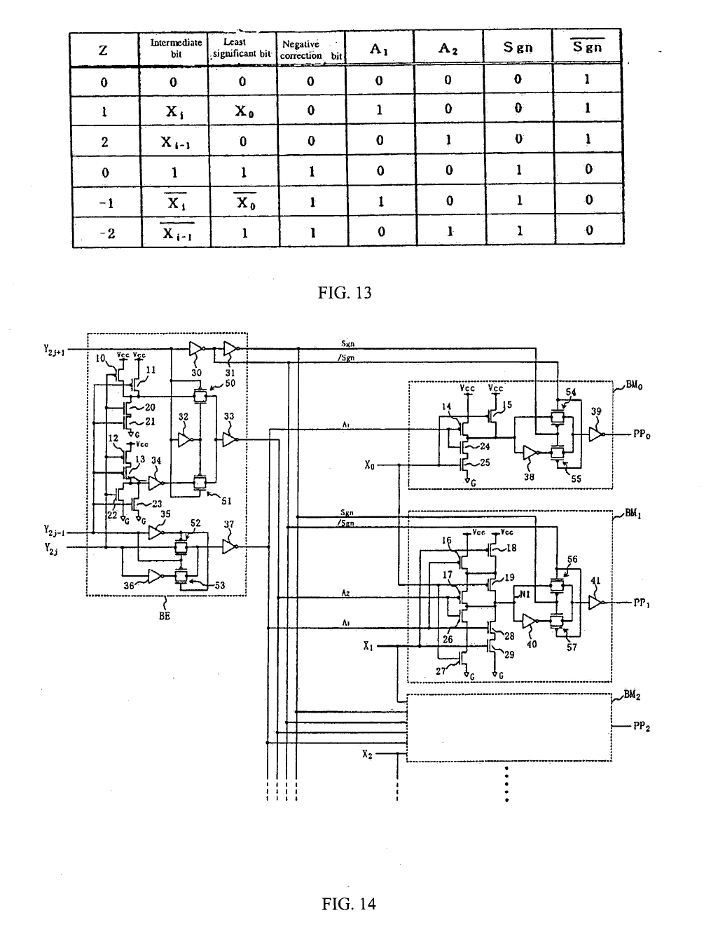

FIG. 8 is a schematic circuit diagram illustrating another example of the constitution of the first encoder.

First encoder Eⱼ₁′ shown in FIG. 8 has inverters 318-321, transfer gate 420 and transfer gate 421.

In first encoder Eⱼ₁′, while bit Y₂ⱼ of the multiplier is input through transfer gate 420 to inverter 320, it is inverted with inverter 318 and is then input through transfer gate 421 to inverter 320. Bit Y₂ⱼ₋₁ of the multiplier is input to the positive input of transfer gate 421 and the negative input of transfer gate 420, and bit Y₂ⱼ₋₁ of the multiplier is inverted with inverter 319 and is then input to the negative input of transfer gate 421 and the positive input of transfer gate 420. Second control code A₂ is output from the output of said inverter 320, and second control code A₂ is inverted with inverter 321 to generate first control code A₁.

First encoder Eⱼ₁′ shown in FIG. 8 is different from first encoder Eⱼ₁ shown in FIG. 2 in that second control code A₂ is inverted with an inverter to generate first control code Al. Due to this difference, first encoder Eⱼ₁′ has one more transistor section than first encoder Eⱼ₁. When this is adopted in the partial product generator, the transistor section of the longest path in this case is 1 less than that of the partial product generator shown in FIG. 14. Also, compared with bit circuit Pⱼᵢ shown in FIG. 2, the number of transistors used in the circuit can be reduced.

As explained above, in the aforementioned partial product generator pertaining to the embodiment of this invention, when the Booth code has value “0,” the value of the partial product can be determined uniquely. Consequently, it is possible to change the process order in the bit circuit. As a result, by using control code (/ZDT) that requires formation time in the latter section circuit of the bit circuit, while using control codes (Sgn, A₁, A₂ ) with a shorter formation time in the former section of the bit circuit, it is possible to reduce the wasteful standby time of the process, and it is possible to realize a higher speed in forming the partial product than in the prior art. As a result, it is possible to increase the overall speed of the multiplier.

Also, when the Booth code has value “0,” the value of the partial product can be determined uniquely. Consequently, generation of a wasteful signal transition as in the partial product generator shown in FIG. 14 is suppressed, and the power consumption of the circuit can be reduced compared to that in the prior art.

This invention is not limited to the aforementioned embodiment.

That is, the aforementioned circuit constitution is merely an example for explaining the embodiment of this invention. This invention also can be realized using other circuits having the same function.

For example, in the aforementioned circuit, p-type MOS transistors and n-type MOS transistors are used. However, any transistor type may be used. For example, one may also use bipolar transistors, and other transistors.

Also, the transfer gates used in the aforementioned circuit may be substituted with other circuits having a switching function.

Any constitution may be adopted for the adder of the partial product. One may adopt various other adders.

According to this invention, it is possible to generate a partial product at high speed. As a result, the multiplication rate can be increased. Also, generation of wasteful signal transition can be prevented. As a result, power consumption can be reduced.

1. A type of partial product generator characterized by the following facts:
in the partial product generator of multiplier, based on one of plural 2-bit data obtained by dividing the supplied multiplier data from the most significant bit at 2-bit intervals, and the 1-bit adjacent data adjacent to the low-order side of said 2-bit data, a prescribed operation is performed for the supplied multiplicand data so as to generate a partial product corresponding to said 2-bit data; in this partial product generator, there are the following parts:
a first encoder that performs exclusive-OR for the low-order data of said 2-bit data and said adjacent data adjacent to said low-order data to generate a first control code, and performs exclusive-NOR for said low-order data and said adjacent data to generate a second control code;
a second encoder that performs exclusive-NOR for the high-order data and the low-order data of said 2-bit data, and performs NAND for said operation result and said second control code, or OR for the NOT result of said operation result and said first control code to generate a third control code;
plural selectors that output the high-order data or low-order data among the adjacent 2-bit data of said multiplicand data corresponding to said first control code and said second control code;
plural bit inverters that invert the logic values of the bits of the multiplicand data output from said plural selectors corresponding to the high-order data of said 2-bit data;
and plural output circuits that perform NAND for each of the bits of the multiplicand data output from said plural bit inverters and said third control code and output the bit data of said partial product.

2. The partial product generator described in claim 1 characterized by the fact that said first encoder has the following parts:
a first node and a second node, one of which has said low-order data input to it, and the other of which has said adjacent data input to it;
a first inverter that inverts the logic value of said first node;
a second inverter that inverts the logic value of said second node;
a first switch which is turned ON/OFF corresponding to the logic value of the output signals of said first node and said first inverter, and which outputs the input signal of said second node when in the ON state;
a second switch which is turned ON/OFF according to the logic value inverted with respect to that of said first switch corresponding to the logic value of the output signals of said first node and said first inverter, and which outputs the output signal of said second inverter when in the ON state;
a third switch which is turned ON/OFF according to the logic value inverted with respect to that of said first switch corresponding to the logic value of the output signals of said first node and said first inverter, and which outputs the input signal of said second node when in the ON state;
a fourth switch which is turned ON/OFF according to the same logic value as that of said first switch corresponding to the logic value of the output signals of said first node and said first inverter, and which outputs the output signal of said second inverter when in the ON state;
a third inverter that receives the output signals of said first switch and said second switch and outputs NOT of the logic value of said output signals as said first control code;
and a fourth inverter that receives the output signals of said third switch and said fourth switch and outputs NOT of the logic value of said output signals as said second control code.

3. The partial product generator described in claim 1 characterized by the fact that said first encoder has the following parts:
a first node and a second node, one of which has said low-order data input to it, and the other of which has said adjacent data input to it;
a first inverter that inverts the logic value of said first node;
a second inverter that inverts the logic value of said second node;
a first switch which is turned ON/OFF corresponding to the logic value of the output signals of said first node and said first inverter, and which outputs the input signal of said second node when in the ON state;
a second switch which is turned ON/OFF according to the logic value inverted with respect to that of said first switch corresponding to the logic value of the output signals of said first node and said first inverter, and which outputs the output signal of said second inverter when in the ON state;
a third inverter that receives the output signals of said first switch and said second switch and outputs NOT of the logic value of said output signals as said first control code or said second control code;
and a fourth inverter that receives the output signal of said third inverter and outputs NOT of the logic value of said output signal as said first control code or said second control code.

4. The partial product generator described in claim 2 or 3 characterized by the fact that a said selector contains
a fifth switch which is turned ON/OFF corresponding to said first control code and second control code, and which outputs the low-order data among the adjacent 2-bit data of said multiplicand data when in the ON state;
and a sixth switch which is turned ON/OFF according to the logic value inverted with respect to that of said fifth switch corresponding to said first control code and second control code, and which outputs the high-order data among said 2-bit data when in the ON state.

5. The partial product generator described in claim 4 characterized by the fact that a said bit inverter contains
a third node;
a fifth inverter that inverts the logic value of the bit data of said multiplicand data output from said selector;
a seventh switch which is connected between the output node of said fifth inverter and the third node and which is turned ON/OFF corresponding to the high-order data of said 2-bit data;
and a sixth inverter which works corresponding to the high-order bit of said 2-bit data and becomes inactive state when said seventh switch is ON and becomes active when said seventh switch is OFF, and in said active state, inverts the logic value of the output signal of said fifth inverter and outputs it to said third node.

6. The partial product generator described in claim 4 characterized by the fact that said bit inverter contains
a third node;
a fifth inverter that inverts the logic value of the bit data of said multiplicand data output from said selector;
a sixth inverter that inverts the logic value of the output signal of said fifth inverter;
a seventh switch which is connected between the output node of said fifth inverter and the third node and which is turned ON/OFF corresponding to the high-order data of said 2-bit data;
and an eighth switch which is connected between the output node of said sixth inverter and said third node, and which is turned ON/OFF according to NOT of the logic value of said seventh switch corresponding to the high-order data of said 2-bit data.

7. The partial product generator described in claim 5 characterized by the following facts:
it contains a third encoder which performs operation to determine the exclusive-OR or exclusive-NOR for the high-order data of said 2-bit data and the input bit inverted signal, and which inverts the logic value of the operation result to form a fourth control code, and further inverts the logic value of said fourth control code to generate a fifth control code;
said seventh switch is turned ON/OFF corresponding to said fourth control code and said fifth control code;
and said sixth inverter enters the active state or inactive state corresponding to said fourth control code and said fifth control code.

8. A type of multiplier characterized by the following facts:
the multiplier has plural partial product generators which perform prescribed operation for supplied multiplicand data to generate partial products corresponding to the plural 2-bit data obtained by dividing the supplied multiplier data from the most significant bit at 2-bit intervals based on said 2-bit data and the 1-bit adjacent data adjacent to the low-order side of said plural 2-bit data, respectively, and an adder that adds the partial products generated in said plural partial product generators; each of said partial product generators has the following parts:
a first encoder that performs exclusive-OR for the low-order data of said 2-bit data and said adjacent data adjacent to said low-order data to generate a first control code, and performs exclusive-NOR for said low-order data and said adjacent data to generate a second control code;
a second encoder that performs exclusive-NOR for the high-order data and the low-order data of said 2-bit data, and performs NAND for said operation result and said second control code, or OR for the NOT result of said operation result and said first control code to generate a third control code;
plural selectors that output the high-order data or low-order data among the adjacent 2-bit data of said multiplicand data corresponding to said first control code and said second control code;
plural bit inverters that invert the logic values of the bits of the multiplicand data output from said plural selectors corresponding to the high-order data of said 2-bit data;
and plural output circuits that perform NAND for each of the bits of the multiplicand data output from said plural bit inverters and said third control code and output the bit data of said partial product.

9. The multiplier described in claim 8 characterized by the fact that said first encoder has the following parts:
a first node and a second node, one of which has said low-order data input to it, and the other of which has said adjacent data input to it;
a first inverter that inverts the logic value of said first node;
a second inverter that inverts the logic value of said second node;
a first switch which is turned ON/OFF corresponding to the logic value of the output signals of said first node and said first inverter, and which outputs the input signal of said second node when in the ON state;
a second switch which is turned ON/OFF according to the logic value inverted with respect to that of said first switch corresponding to the logic value of the output signals of said first node and said first inverter, and which outputs the output signal of said second inverter when in the ON state;
a third switch which is turned ON/OFF according to the logic value inverted with respect to that of said first switch corresponding to the logic value of the output signals of said first node and said first inverter, and which outputs the input signal of said second node when in the ON state;
a fourth switch which is turned ON/OFF according to the same logic value as that of said first switch corresponding to the logic value of the output signals of said first node and said first inverter, and which outputs the output signal of said second inverter when in the ON state;
a third inverter that receives the output signals of said first switch and said second switch and outputs NOT of the logic value of said output signals as said first control code;
and a fourth inverter that receives the output signals of said third switch and said fourth switch and outputs NOT of the logic value of said output signals as said second control code.

10. The multiplier described in claim 9 characterized by the fact said selector contains
a fifth switch which is turned ON/OFF corresponding to said first control code and second control code, and which outputs the low-order data among the adjacent 2-bit data of said multiplicand data when in the ON state;
and a sixth switch which is turned ON/OFF according to the logic value inverted with respect to that of said fifth switch corresponding to said first control code and second control code, and which outputs the high-order data among said 2-bit data when in the ON state.

11. The multiplier described in claim 10 characterized by the fact that said bit inverter contains
a third node;
a fifth inverter that inverts the logic value of the bit data of said multiplicand data output from said selector;
a seventh switch which is connected between the output node of said fifth inverter and the third node and which is turned ON/OFF corresponding to the high-order data of said 2-bit data;
and a sixth inverter which works corresponding to the high-order bit of said 2-bit data and enters the inactive state when said seventh switch is ON and enters the active when said seventh switch is OFF, and, in said active state, inverts the logic value of the output signal of said fifth inverter and outputs it to said third node.

12. The multiplier described in claim 11 characterized by the following facts:
it contains a third encoder which performs operation to determine the exclusive-OR or exclusive-NOR for the high-order data of said 2-bit data and the input bit inverted signal, and which inverts the logic value of the operation result to form a fourth control code, and further inverts the logic value of said fourth control code to generate a fifth control code;
said seventh switch is turned ON/OFF corresponding to said fourth control code and said fifth control code;
and said sixth inverter enters the active state or inactive state corresponding to said fourth control code and said fifth control code.
